(19) United States
(12) Patent Application Publication
(10) Pub. No.: US 2017/0249843 A1
(43) Pub. Date: Aug. 31, 2017

(54) Classic Car Alert System

(71) Applicant: Christopher Joseph Rence, Balsam Lake, WI (US)

(72) Inventor: Christopher Joseph Rence, Balsam Lake, WI (US)

(21) Appl. No.: 14/214,995

(22) Filed: Mar. 16, 2014

(51) Int. Cl. G08G 1/16; B62D 1/04; B60Q 1/44; B60Q 1/38

(52) U.S. Cl. CPC G08G 1/166; B60Q 1/38; B62D 1/046; B60Q 1/441

(57) ABSTRACT

An alert system for a classic car is described. It is well known that classic cars lack the majority of safety features offered on modern vehicles. In addition, driver/owners of classic cars operate them in an environment far different from that which they were created to operate. Therefore, the addition of safety features provides a substantial benefit to driver/owners of classic cars. A classic car alert system is a radio frequency device which sends a signal to a receiving unit mounted to a classic car, providing a third brake light, turn signals and an audible alarm between vehicles. This provides vintage cars with safety features without modifying the vehicle in a way that detracts from its value, appearance, or requires a major rewire of the car systems.

### RELATED APPLICATIONS

This application claims the benefit of U.S. Provisional Application No. 61/802,622 filed Mar. 16, 2013, entitled “Classic Car Alert System,” which is incorporated herein by reference.

### FIELD OF THE INVENTION

The present invention relates to classic cars, particularly with regard to safety devices and systems.

### BACKGROUND

The Classic Car Club of America (CCCA) defines a Classic Car as a “fine” or “distinctive” automobile, either American or foreign built, produced between 1925 and 1948. Other factors, including engine displacement, custom coachwork and luxury accessories, such as power brakes, power clutch, and “one-shot” or automatic lubrication systems, help determine whether a car is considered a Classic. Although this definition is not universally accepted with respect to the year of manufacture, it is generally believed that there are no classic cars which include the modern safety features that are available today.

Today, owners of USA registered vintage and classic cars typically range in age from 60 to 90 years. These drivers are operating cars with no power steering, disc or cable-based brakes and 6-volt lighting systems that produce very low intensity brake lighting in a very different environment than it was in the 1950's. In addition, drivers use arm signals for turning which allows limited time to react by other motorists.

The driving environment of the 1950s and earlier was a very different one that it is today. The number of the cars on the road was significantly lower than today, and the cars were not capable of driving at the speeds of today's models. Additionally, cars considered classic cars have few, if any, of the safety features available in modern automobiles. Cars of that era came with significantly fewer features than even the most basic car today—there were no on-board computers, air conditioning, central locking power steering, disc or cable-based brakes and very few, if any, gauges of car performance except crude indicators of speed and fuel level. Safety features were rare and usually limited to larger bumpers or a recommendation to wear driving gloves to improve the driver's grip on the wheel. Many cars had no indicators such as turn signals, warning light or alerts. According to a study conducted by the U.S. Insurance Institute of Highway Safety, modern car design is vastly safer than the classic cars of the 50's. Retrofitting is often not possible due to body/frame design as well as the owner's desire to maintain originality.

The present invention provides a solution to these needs and other problems, and offers other advantages over the prior art.

### BRIEF SUMMARY

Owners of USA registered vintage and classic cars typically range in age from 60 to 90 years. They operate cars with no power steering, disc or cable-based brakes and 6-Volt lighting systems that produce very low intensity brake lighting; they use arm signals for turning which allows limited time to react by other motorists.

A classic car alert system is a radio frequency device which sends a signal to a receiving unit mounted to a classic car, providing a third brake light, turn signals and an audible alarm between vehicles. This allows vintage cars to have safety features without modifying the vehicle that will detract from its value, appearance, or require a major rewire of the car systems. The system also allows for a range alarm if one classic car is getting too close to another classic car that is also equipped with the classic car alert system.

One embodiment of a vehicle alert system comprises a brake sensing and transmitter unit that slips over a brake pedal of a vehicle, the unit further comprising a battery and pressure sensing unit; a turn signal sending unit attached to an interior location easily accessible by a driver, the turn signal sending unit comprising switches for a right and a left turn signal; a proximity sensor and receiving unit operatively configured to sense the proximity of nearby vehicles and send an audible and visual alert indicator; the proximity sensor capable of being programmed for sensing vehicles at a preset distance from the vehicle; and an exterior receiving unit comprising a set of turn signal indicators.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 is a diagram of a brake pedal sensing harness with sensing unit and battery.

FIG. 2 illustrates a brake pedal sensing device in context.

FIG. 3 illustrates the exterior of an exemplary classic car alert system control unit.

FIG. 4 illustrates a classic car alert system control unit attached to a steering wheel.

FIG. 5 is a diagram illustrating the power source, circuitry and components of a classic car alert system.

FIG. 6 illustrates the classic car alert system unit indicator components.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The driving environment of the 1950s and earlier was a very different one that it is today. The number of the cars on the road was significantly lower than today, and the cars were not capable of driving at the speeds of today's models. Cars of that era came with significantly fewer features than even the most basic car today—there were no on-board computers, air conditioning, central locking or no power steering, disc or cable-based brakes and very few, if any, gauges of car performance except crude indicators of speed and fuel level. Safety features were rare and usually limited to larger bumpers or a recommendation to wear driving gloves to improve the driver's grip on the wheel. Many cars had no indicators such as turn signals, warning light or alerts.

Today, owners of USA registered vintage and classic cars typically range in age from 60 to 90 years. They operate cars with no power steering, disc or cable-based brakes and 6-volt lighting systems that produce very low intensity brake lighting; they use arm signals for turning which allows limited time to react by other motorists. A classic car alert system is a radio frequency device which sends a signal to a receiving unit mounted to a classic car, providing a third brake light, turn signals and an audible alarm between vehicles. This allows vintage cars to have safety features without modifying the vehicle that will detract from its value, appearance, or require a major rewire of the car systems. The system also allows for a range alarm if one classic car is getting too close to another classic car that is also equipped with the classic car alert.

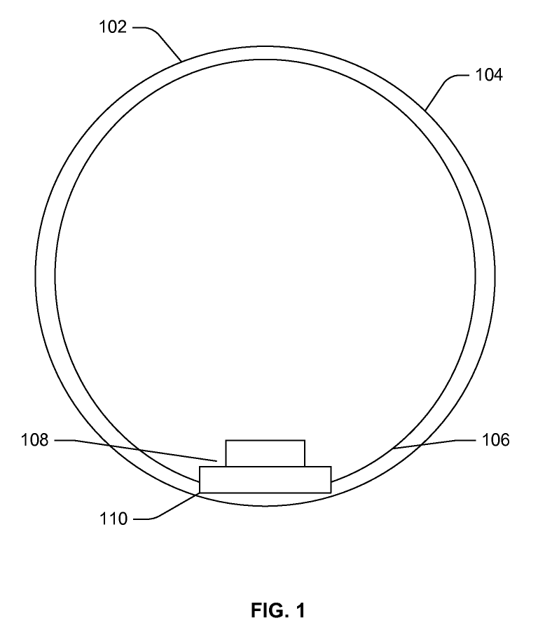

As will be discussed below in reference to FIGS. 1-6, a preferred embodiment of a classic car alert system includes a brake sensing and transmitter unit that slips over the brake pedal of the vehicle; a turn signal sending unit attached to the vehicle steering wheel or other easily accessible location, the turn signal transmitter comprising two toggle switches to engage the left and right turn signals and an audible alert indicator for a proximity sensor; a proximity receiving unit that attaches to the outside of the vehicle. The receiving unit may also comprise a set of turn signal indicators with or without a brake light and proximity indicator. The system units and modules are individually powered by batteries to avoid using vehicle resources and making any permanent modifications to the vehicle.

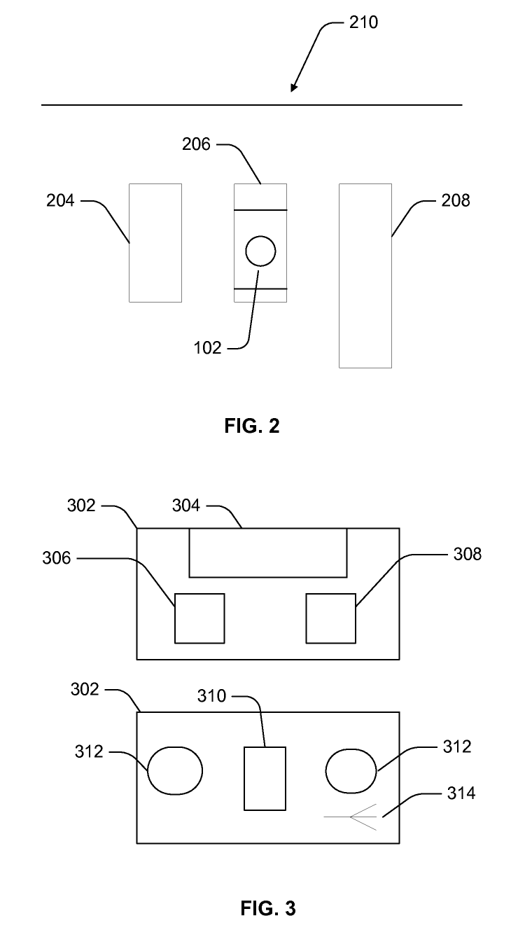

FIG. 1 illustrates a brake pedal sensing harness 102. This unit may consist of a rubber gasket to fit the sensing device around the brake pedal 104, a lead sensing wire 106, a 1.2v battery 108, and a pressure sensing unit 110. Referring now to FIG. 2, a typical pedal configuration 202 for a pre-1950's classic car consists of a clutch 204, a brake pedal 206 and an accelerator pedal 208 located under the driver side dash board 210. The brake pedal sensing harness 102 may be attached to the brake pedal as illustrated.

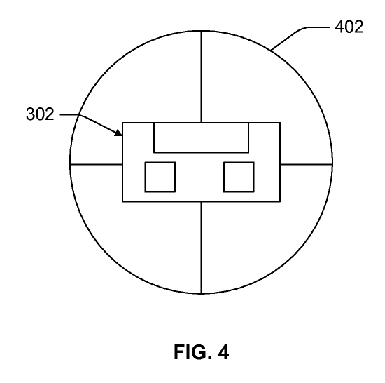

FIG. 3 illustrates the exterior of an exemplary classic car alert system control unit 302. The control unit housing unit has an exterior with front and back sides and an interior housing the components and circuitry. The front of the unit comprises, at a minimum, a proximity alarm 304, a left turn button 306 and a right turn button 308 with which to operate the turn signals. One of ordinary skill in the art will recognize that other controls may be added, or other configurations may be made, without departing from the scope and spirit of the invention. The back of the unit comprises a receptacle and connections for a battery 310, an attachment means for attaching the unit to the car 312, and an antenna 314. One of ordinary skill in the art will recognize that the unit may be attached by an attachment means that preferably causes no damage to the car interior, such as a magnetic attachment, suction cups, Velcro®, or other non-destructive means. In addition, a substance or material, such as felt or foam rubber, may be added to provide a cushion between the unit and the car.

FIG. 4 shows the control unit attached to the steering wheel 402. The control unit may be installed at any convenient location within the drivers reach, however, in a preferred embodiment, the unit is attached to the steering wheel, as this installation allows the driver greatest ease of access and control.

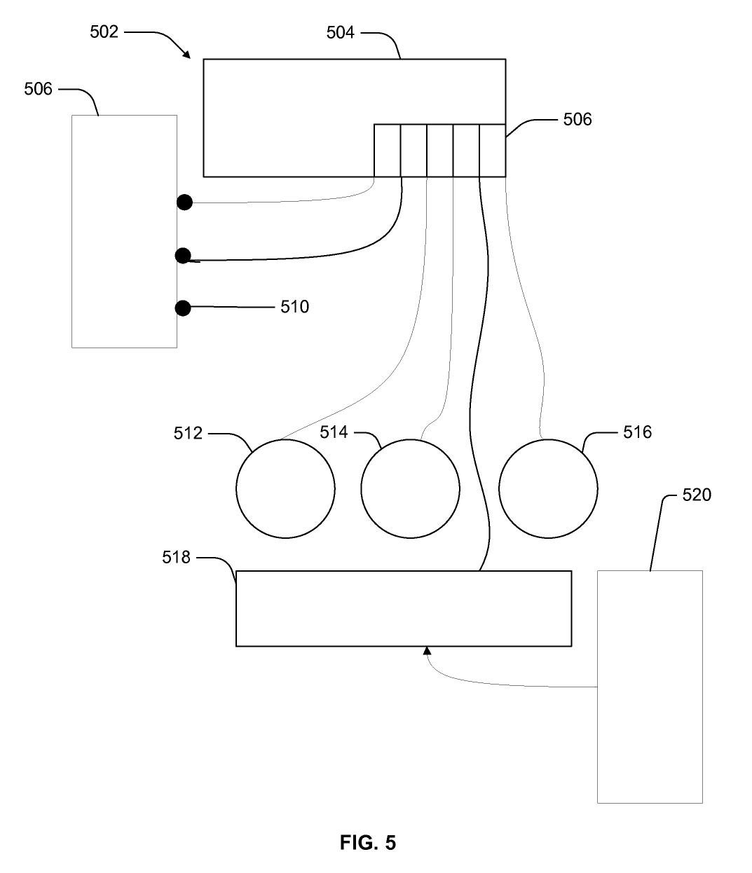

FIG. 5 illustrates the power source, circuitry and components of a classic car alert system. A battery housing unit 502 includes a battery receptacle 504 and terminals 506, circuit board 508, antenna 510, wiring to the left turn indicator light 512, the brake light 514, the right turn indicator light 516, the proximity sensing device transmitter/receiving unit 518 and the proximity sensing receiver circuit board 520.

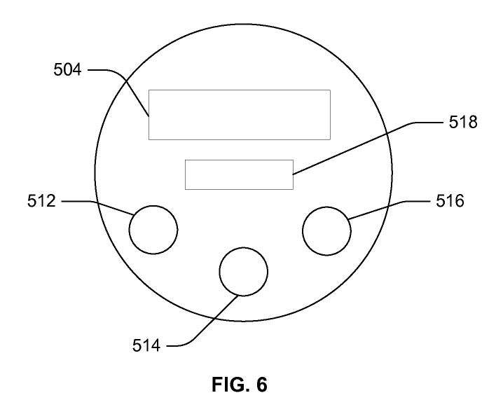

FIG. 6 illustrates the classic car alert system unit external indicator components 602. These components may be housed in one or more housing units and placed on the vehicle in a manner that allows nearby vehicles to clearly view the indicators. The components include a battery 504, left turn indicator light 512, brake indicator light 514, right turn indicator light 516, and the proximity receiving unit 518.

Drivers may activate the turn signals by operating the switches on the front of the control unit to indicate that they are turning left 106 or right 108. Operating either switch illuminates the corresponding exterior lamp 512, 516 to indicate the turn. Depressing the brake pedal activates the transmitter in the brake harness; in response, the brake light 514 is illuminated. The transmitter-receiver may be wirelessly or radio frequency controlled.

A proximity alert receiving unit may attach to the rear or top of the car by attachment means, such as a magnetic base. Other attachment means, such as nails, screws, or other fasteners may be used but one objective of a preferred embodiment is to avoid any kind of damage to the vehicle. For that reason, a non-destructive method is preferred. The receiving unit comprises a sensor which may be programmed to detect objects within a particular distance. It is preferable to have the range of the sensor set so that objects are detected from a far enough distance to give the driver adequate time to stop before a collision occurs. On the other hand, it is also preferable not to set the range too far so that a warning indication is generated in situations where there is little likelihood of collision. For this reason, a distance of 50 feet may reasonable for a preferred embodiment of the classic car alert system.

As was described above, a proximity alert component comprises a receiving unit with proximity sensor and a transmitting unit to sound an audible alarm and activate a switch to turn on the proximity warning light. The proximity alert system may include a proximity sensor for positioning adjacent the rear or top of the vehicle. A proximity sensor connector connects the proximity sensor to the control unit battery so that the proximity sensor is powered and operable to detect proximity of an object within a pre-set distance adjacent the rear of the vehicle.

The transmitter-receiver may be wirelessly or radio frequency controlled. When the transmitter is activated, either by a driver depressing the brake, activating a signal switch or the proximity sensor detecting a nearby vehicle, a wireless or radio frequency signal is sent to the receiver where the brake light or a turn signal is lit, or the proximity alert sounds an audible alarm or activates the warning light.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle alert system, comprising:
a brake sensing and transmitter unit comprising a battery and pressure sensing unit;
a turn signal sending unit comprising switches for a right and a left turn signal;
a programmable proximity sensor and receiving unit operatively configured to sense the proximity of nearby vehicles and send an alert indicator; and
an exterior receiving unit comprising a set of turn signal indicators.
